(19) United States
(12) Patent Application Publication
(10) Pub. No.: US 2023/0415274 A1
(43) Pub. Date: Dec. 28, 2023

(54) METHOD OF MANUFACTURING WAFER

(71) Applicant: DISCO CORPORATION, Tokyo (JP)

(72) Inventor: Hayato IGA, Tokyo (JP)

(21) Appl. No.: 18/338,866

(22) Filed: Jun. 21, 2023

(30) Foreign Application Priority Data
Jun. 27, 2022 (JP) 2022-102944

(51) Int. Cl. B23K 26/53; B23K 26/08

(52) U.S. Cl. CPC B23K 26/53; B23K 26/0869; B23K 26/0853; B23K 2101/40

(57) ABSTRACT

A method of manufacturing a wafer includes an entire plane processing step and a separating step. The entire plane processing step repeats a separation initiating point forming step of, while positioning a focused spot of a laser beam within an ingot, moving the focused spot and the ingot relatively to each other along a predetermined processing feed direction, thereby forming in the ingot separation initiating points including modified layers in a plane parallel to a first surface of the ingot and cracks developed from the modified layers, and an indexing feed step of indexing-feeding the focused spot of the laser beam relatively to the ingot in a direction perpendicular to the processing feed direction. The separating step separates a wafer from the ingot along the separation initiating points.

### BACKGROUND OF THE INVENTION

### Field of the Invention

The present invention relates to a method of manufacturing a wafer.

### Description of the Related Art

There has been known a wire saw as means for slicing an Si ingot made of silicon (Si), a compound semiconductor ingot, or the like into wafers. The wire saw includes a plurality of cutting wires trained around a plurality of rollers, making up a wire web. The cutting wires are forced to cut into an ingot and move through the ingot, slicing the ingot into wafers (see, for example, Japanese Patent Laid-open No. Hei 9-262826).

However, a wire saw for slicing an ingot into wafers has a relatively large wire width of approximately 300 μm per wire. In addition, the wafers produced from the ingot need to have their surfaces planarized by lapping, etching, and polishing. As a result, the amount of the material of an ingot that is wasted when wafers are manufactured from the ingot is so large that the amount of the material of the wafers produced from the ingot is approximately ⅓ of the ingot. Consequently, the productivity of wafers has heretofore been quite low. In view of the productivity issue, the applicant of the present invention has developed a method of efficiently manufacturing Si wafers from an Si ingot by applying a laser beam to the Si ingot (see, for example, Japanese Patent Laid-open No. 2022-25566).

### SUMMARY OF THE INVENTION

The method disclosed in Japanese Patent Laid-open No. 2022-25566 is able to reduce the amount of the material of ingots that is wasted, but suffers a low throughput because it processes an ingot to manufacture wafers one by one.

It is therefore an object of the present invention to provide a method of manufacturing a wafer from an ingot while reducing a waste of material of the ingot and increasing the throughput.

In accordance with an aspect of the present invention, there is provided a method of manufacturing a wafer from an ingot having a first surface and a second surface that is opposite the first surface, the method including an entire plane processing step and a separating step. The entire plane processing step repeats a separation initiating point forming step of, while positioning a focused spot of a laser beam whose wavelength is transmittable through a material of the ingot within the ingot from the first surface side, moving the focused spot and the ingot relatively to each other along a predetermined processing feed direction, thereby forming in the ingot separation initiating points including modified layers in a plane parallel to the first surface and cracks developed from the modified layers, and an indexing feed step of indexing-feeding the focused spot of the laser beam relatively to the ingot in a direction perpendicular to the processing feed direction. The separating step separates a wafer from the ingot along the separation initiating points, after the entire plane processing step has been carried out. The separation initiating point forming step includes forming a plurality of focused spots of the laser beam that are spaced thicknesswise of the ingot from each other in the ingot by a distance corresponding to a thickness of the wafer to be separated from the ingot, thereby simultaneously forming a plurality of layers of separation initiating points at respective different depths in the ingot in the entire plane processing step.

The focused spots formed in the ingot and spaced thicknesswise of the ingot from each other may be arranged in respective different positions along the processing feed direction such that the ingot is processed successively at the focused spots in an order from the deepest focused spot to a shallower focused spot.

The ingot may be a monocrystalline silicon ingot having a flat surface representing a crystal plane {100}, and the processing feed direction in the separation initiating point forming step may be a direction parallel to a crystal orientation <100>.

The ingot may be a monocrystalline gallium nitride ingot having a flat surface representing a crystal plane {0001}, and the processing feed direction in the separation initiating point forming step may be a direction parallel to a crystal orientation <11-20>.

According to the aspect of the present invention, the method of manufacturing a wafer has an increased throughput while lowering the loss of the material wasted from the ingot.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of an ingot to be processed by a method of manufacturing a wafer according to an embodiment of the present invention;

FIG. 2 is a plan view of the ingot illustrated in FIG. 1;

FIG. 3 is a flowchart illustrating a sequence of the method of manufacturing a wafer according to the embodiment;

FIG. 4 is a schematic view, partly in block form, illustrating an example of a separation initiating point forming step illustrated in FIG. 3;

FIG. 5 is a perspective view illustrating a state in an entire plane processing step illustrated in FIG. 3;

FIG. 6 is a plan view of the ingot illustrated in FIG. 5;

FIG. 7 is a side elevational view, partly in cross section, illustrating an example of a separating step illustrated in FIG. 3;

FIG. 8 is a side elevational view illustrating a first separating step in another example of the separating step illustrated in FIG. 3;

FIG. 9 is a side elevational view illustrating a second separating step in the other example of the separating step illustrated in FIG. 3;

FIG. 10 is a perspective view of an ingot to be processed by a method of manufacturing a wafer according to a modification of the present invention; and

FIG. 11 is a plan view of the ingot illustrated in FIG. 10.

### DETAILED DESCRIPTION OF THE PREFERRED EMBODIMENT

A preferred embodiment of the present invention will be described in detail hereinbelow with reference to the accompanying drawings. The present invention is not limited to the details of the embodiment described below. Components described below cover those which could easily be anticipated by those skilled in the art and those which are essentially identical to those described below. Furthermore, arrangements described below can be combined in appropriate manners. Various omissions, replacements, or changes of the arrangements may be made without departing from the scope of the present invention. In the description below, those components that are identical to each other are denoted by identical reference symbols.

### EMBODIMENT

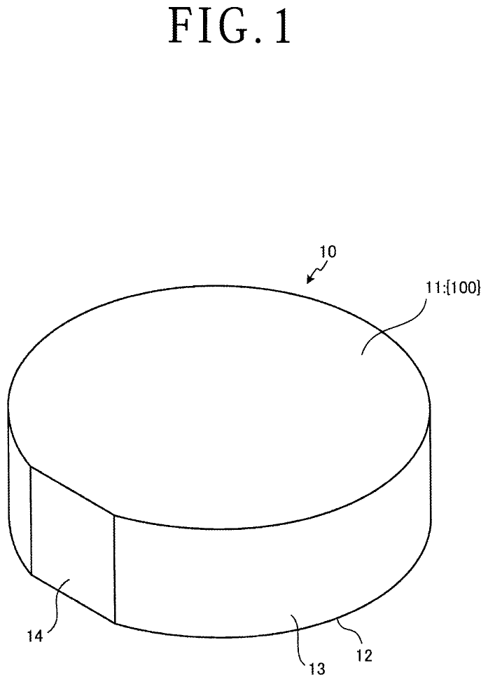

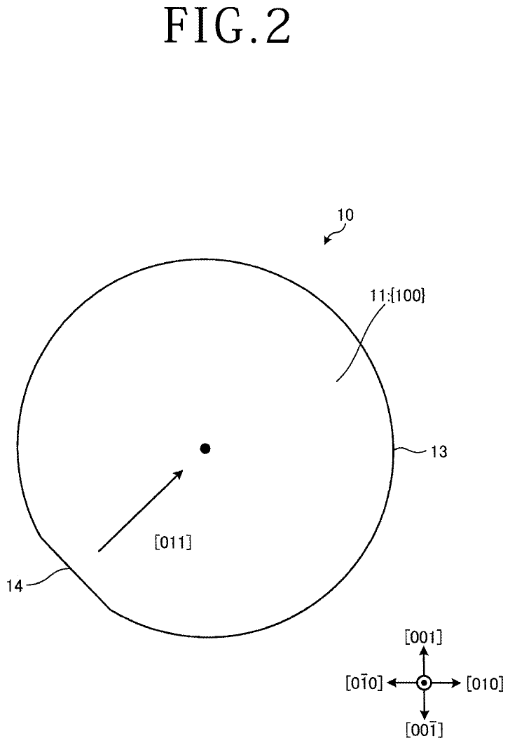

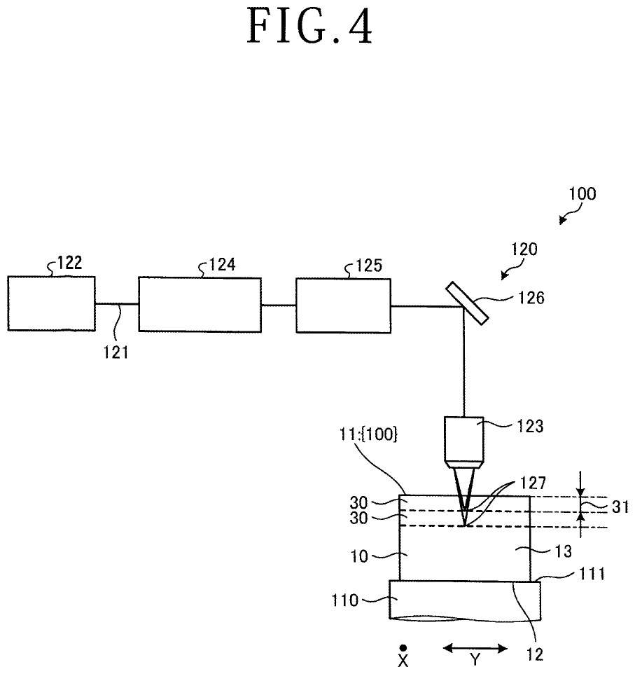

A method of manufacturing a wafer 30 according to the embodiment of the present invention will be described below with reference to the accompanying drawings. The method of manufacturing a wafer 30 according to the embodiment is a method of manufacturing the wafer 30 illustrated in FIG. 4, etc. from an ingot 10 illustrated in FIGS. 1 and 2.

### (Monocrystalline Si Ingot)

First, a structure of the ingot 10 to be processed by the method of manufacturing a wafer 30 according to the embodiment will be described below. FIG. 1 illustrates in perspective the ingot 10 to be processed by the method of manufacturing a wafer 30 according to the embodiment. FIG. 2 illustrates in plan the ingot 10 illustrated in FIG. 1.

The ingot 10 according to the embodiment illustrated in FIGS. 1 and 2 is made of monocrystalline silicon (Si) and is of a cylindrical shape in its entirety. The ingot 10 has a first surface 11, a second surface 12, a peripheral surface 13, and an orientation flat 14.

The first surface 11 is a circular flat end face of the ingot 10 that is cylindrical in shape. The first surface 11 represents a top face of the ingot 10 that faces upwardly. The second surface 12 is also a circular flat end face of the ingot 10 that is opposite the first surface 11. The second surface 12 represents a bottom face of the ingot 10 that faces downwardly. The peripheral surface 13 is joined to an outer edge of the first surface 11 and an outer edge of the second surface 12. The orientation flat 14 is a flat surface formed on a portion of the peripheral surface 13 and indicates a crystal orientation of the ingot 10.

On the ingot 10, the first surface 11 represents a crystal plane {100}, and the orientation flat 14 represents a crystal plane {011}. In the present description, a Miller index that is negative is indicated with a negative sign “−” added in front of it.

### (Method of Manufacturing Wafer 30)

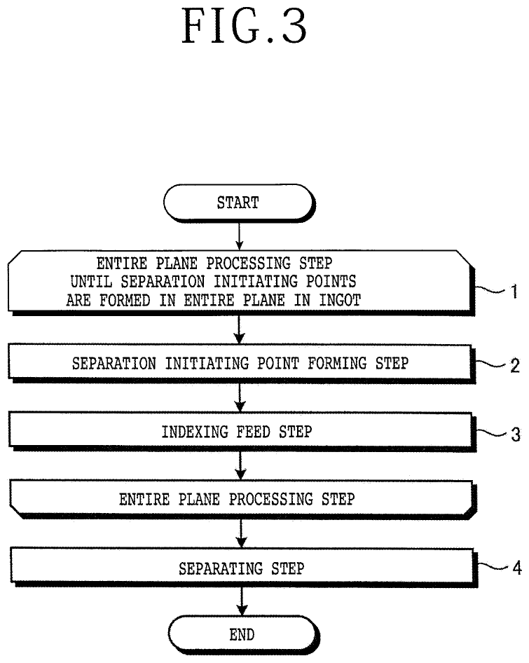

Next, the method of manufacturing a wafer 30 according to the present embodiment will be described below. FIG. 3 is a flowchart illustrating a sequence of the method of manufacturing a wafer 30 according to the present embodiment. The method of manufacturing a wafer 30 includes an entire plane processing step 1 and a separating step 4. The entire plane processing step 1 includes a separation initiating point forming step 2 and an indexing feed step 3 which are repeated a predetermined number of times.

In the description that follows, an X-axis direction represents a direction in a horizontal plane, and a Y-axis direction represents a direction perpendicular to the X-axis direction in the horizontal plane. According to the present embodiment, the X-axis direction indicates a processing feed direction and represents a crystal orientation [010]. According to the present embodiment, the Y-axis direction indicates an indexing feed direction and represents a crystal orientation [001].

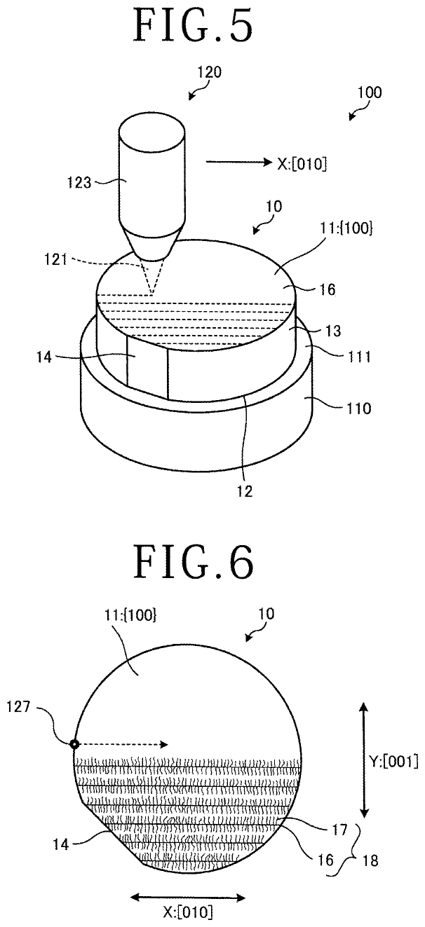

FIG. 4 schematically illustrates, partly in block form, an example of the separation initiating point forming step 2 illustrated in FIG. 3. FIG. 5 illustrates in perspective a state in the entire plane processing step 1 illustrated in FIG. 3. FIG. 6 illustrates in plan the ingot 10 illustrated in FIG. 5. The entire plane processing step 1 is a step of forming separation initiating points 18 in essentially entire planes in the ingot 10 by repeating the separation initiating point forming step 2 and the indexing feed step 3.

According to the present embodiment, the entire plane processing step 1 is carried out using a laser processing apparatus 100 illustrated in FIGS. 4 and 5. The laser processing apparatus 100 includes a holding table 110, a laser beam applying unit 120, a moving unit, not illustrated, for moving the holding table 110 and the laser beam applying unit 120 relatively to each other, and an image capturing unit, not illustrated.

The holding table 110 holds the ingot 10 on a holding surface 111 thereof. The holding surface 111 is made of porous ceramic or the like in the shape of a circular plate. According to the present embodiment, the holding surface 111 represents a flat surface lying parallel to the horizontal plane. The holding surface 111 is connected to a vacuum suction source through a vacuum suction channel, for example. The holding table 110 holds under suction the second surface 12 of the ingot 10 placed on the holding surface 111.

The laser beam applying unit 120 applies a laser beam 121, whose wavelength is transmittable through the material of the ingot 10, to the ingot 10 held on the holding surface 111 of the holding table 110. The laser beam applying unit 120 converges the laser beam 121 into a focused spot 127 positioned within the ingot 10. The focused spot 127 and the holding table 110 are movable relatively to each other by the non-illustrated moving unit. Alternatively, the focused spot 127 and the holding table 110 may be moved relatively to each other by a scanning unit that scans the ingot 10 with the laser beam 121, rather than by the moving unit. As illustrated in FIG. 4, the laser beam applying unit 120 has a laser oscillator 122, a beam condenser 123, an output adjusting unit 124, a branching unit 125, and a mirror 126.

The laser oscillator 122 emits the laser beam 121 that has a predetermined wavelength for processing the ingot 10. Specifically, the wavelength of the laser beam 121 that is emitted by the laser oscillator 122 is transmittable through the material of the ingot 10, as described above.

The beam condenser 123 includes a condensing lens for converging the laser beam 121 emitted by the laser oscillator 122 into the focused spot 127 and applying the converged laser beam 121 to the ingot 10 held on the holding surface 111 of the holding table 110. The focused spot 127 of the laser beam 121 converged by the beam condenser 123 is positioned within the ingot 10. Specifically, the focused spot 127 is positioned in at least two different vertical positions, i.e., positioned at at least two different heights, in the ingot 10 by the branching unit 125. In other words, the branching unit 125 branches the laser beam 121 into a plurality of, i.e., two, laser beams such that the laser beams have respective focused spots 127 positioned in at least two respective vertical positions in the ingot 10, as described later.

The output adjusting unit 124 is disposed in an optical path between the laser oscillator 122 and the branching unit 125 and adjusts an output level of the laser beam 121 that travels through the output adjusting unit 124. The output adjusting unit 124 includes, for example, a half-wave (λ/2) plate, a beam splitter, and an attenuator including a beam damper, etc. The λ/2 plate changes a direction of linear polarization of the laser beam 121 applied thereto, depending on an angle of rotation. The beam splitter reflects toward the beam damper a laser beam component, of the laser beam 121 that has passed through the λ/2 plate, having a predetermined direction of linear polarization, and transmits therethrough another laser beam component having a direction of linear polarization other than the predetermined direction of linear polarization.

The branching unit 125 is disposed in an optical path between the output adjusting unit 124 and the beam condenser 123 and branches the laser beam 121 applied thereto into at least two laser beams having respective two focused spots 127. The branching unit 125 includes a diffractive optical element or a spatial light modulator. The diffractive optical element has a function to branch the applied laser beam 121 into a plurality of laser beams having respective focused spots 127 by way of diffraction. The spatial light modulator has a function to modulate the applied laser beam 121 by electrically controlling a spatial distribution of amplitudes, phases, polarizations, etc. of the laser beam 121 applied to a display section that displays a predetermined pattern.

The branching unit 125 branches the applied laser beam 121 in a depthwise direction of the ingot 10. The branching unit 125 also branches the applied laser beam 121 slightly in a processing feed direction represented by an arrow X. Specifically, the respective focused spots 127 of the laser beams 121 branched by the branching unit 125 and converged by the beam condenser 123 are arranged in slightly different positions along the processing feed direction such that the ingot 10 is processed successively at the focused spots 127 in an order from the deepest focused spot 127 to the shallower focused spot 127. The focused spots 127 arranged in the slightly different positions along the processing feed direction are spaced from each other along the processing feed direction by a distance that is approximately 30% of a diameter of each of the laser beams 121 applied to the first surface 11 of the ingot 10. For example, if the diameter of each of the laser beams 121 applied to the first surface 11 of the ingot 10 is approximately 200 μm, then the distance between the focused spots 127 that are spaced from each other along the processing feed direction is set to 60 μm.

The mirror 126 reflects the laser beams 121 from the branching unit 125 toward the beam condenser 123. In other words, the mirror 126 reflects the laser beams 121 toward the ingot 10 held on the holding surface 111 of the holding table 110.

The separation initiating point forming step 2 is a step of forming separation initiating points 18 including modified layers 16 in planes parallel to the first surface 11 that represents the crystal plane {100} and cracks 17 developed from the modified layers 16. In the separation initiating point forming step 2, a plurality of layers of separation initiating points 18 are formed at different depths in the ingot 10.

When the laser processing apparatus 100 starts to carry out the separation initiating point forming step 2, the second surface 12 of the ingot 10 is held under suction on the holding surface 111 of the holding table 110. Then, the non-illustrated image capturing unit captures an image of the first surface 11 of the ingot 10 held on the holding table 110. Using the captured image, the laser processing apparatus 100 carries out alignment for positioning the laser beam applying unit 120 and the ingot 10 into alignment with each other.

In the alignment, specifically, the ingot 10 is horizontally directed such that the orientation flat 14 of the ingot 10 is inclined at 45° to the processing feed direction, i.e., the X-axis direction, and the processing feed direction extends parallel to the crystal orientation [010]. In addition, the beam condenser 123 of the laser beam applying unit 120 is positioned above an end of an outer edge portion of the ingot 10 in the X-axis direction representing the processing feed direction.

In the separation initiating point forming step 2, then, the focused spots 127 of the laser beams 121 to be applied to the ingot 10 are positioned within the ingot 10 at respective vertical positions or depths from the first surface 11 of the ingot 10. Specifically, the focused spots 127 of the laser beams 121 to be applied to the ingot 10 are spaced from each other thicknesswise of the ingot 10 by a distance corresponding to a thickness 31 (see FIG. 4) of a wafer 30 to be manufactured from the ingot 10. The thickness 31 of the wafer 30, i.e., the distance between the focused spots 127, is 200 μm, for example.

In the separation initiating point forming step 2, next, in the state in which the focused spots 127 of the laser beams 121 applied to the ingot 10 are being positioned within the ingot 10, while the beam condenser 123 of the laser beam applying unit 120 and the holding table 110 are moved relatively to each other in the processing feed direction, i.e., the X-axis direction, the laser beams 121 are applied to the ingot 10.

The focused spots 127 of the applied laser beams 121 as they move in the processing feed direction form modified layers 16 in the ingot 10 along the crystal orientation represented by the processing feed direction at the depths where the focused spots 127 are positioned. At the same time, cracks 17 are developed from the modified layers 16 in planes substantially parallel to the first surface 11 in opposite directions along the indexing feed direction indicated by the Y-axis direction. In the separation initiating point forming step 2, the modified layers 16 and the cracks 17 extending from the modified layers 16 in the planes substantially parallel to the first surface 11 jointly make up separation initiating points 18 in the ingot 10.

When the modified layers 16 have been formed in the ingot 10 from one end to the other of the outer edge portion thereof along the processing feed direction, i.e., the X-axis direction, the laser beam applying unit 120 temporarily stops applying the laser beams 121, and then the laser processing apparatus 100 carries out the indexing feed step 3.

The indexing feed step 3 is a step of moving, i.e., indexing-feeding, the focused spots 127 of the laser beams 121 relatively to the ingot 10 in the indexing feed direction, i.e., the Y-axis direction, perpendicular to the processing feed direction, i.e., the X-axis direction. In the indexing feed step 3, the holding table 110 is moved in the indexing feed direction, i.e., the Y-axis direction, and is also moved in a direction opposite the processing feed direction, i.e., the X-axis direction. The beam condenser 123 of the laser beam applying unit 120 is positioned above the end of the outer edge portion of the ingot 10 in the X-axis direction representing the processing feed direction, adjacent to a position where the modified layers 16 have already been formed in the ingot 10. Thereafter, the laser processing apparatus 100 carries out the separation initiating point forming step 2 again.

In the separation initiating point forming step 2 carried out again, as with the preceding separation initiating point forming step 2, in the state in which the focused spots 127 of the laser beams 121 applied to the ingot 10 are being positioned within the ingot 10, while the beam condenser 123 of the laser beam applying unit 120 and the holding table 110 are moved relatively to each other in the processing feed direction, i.e., the X-axis direction, the laser beams 121 are applied to the ingot 10.

The focused spots 127 of the applied laser beams 121 as they move in the processing feed direction form modified layers 16 in the ingot 10 along the processing feed direction, adjacent to the modified layers 16 formed in the preceding separation initiating point forming step 2, and cracks 17 developed from the modified layers 16 in opposite directions along the indexing feed direction. The modified layers 16 and the cracks 17 thus formed jointly make up separation initiating points 18 in the ingot 10, adjacent to the separation initiating points 18 formed in the preceding separation initiating point forming step 2. Thereafter, the separation initiating point forming step 2 and the indexing feed step 3 are repeated to form separation initiating points 18 in substantially entire planes in the ingot 10. The separation initiating points 18 thus formed in the ingot lie in upper and lower layers or planes that are spaced from each other by a distance corresponding to the thickness 31. The upper and lower layers of the separation initiating points 18 function as peel-off layers from which flat sections or slices of the ingot 10 will be peeled off as wafers 30 in the separating step 4 to be described later. Now, the entire plane processing step 1 that includes the separation initiating point forming step 2 and the indexing feed step 3 comes to an end, followed by the separating step 4.

In the entire plane processing step 1, the processing feed direction is not limited to the crystal orientation described above, and may represent an equivalent crystal orientation. Specifically, the processing feed direction, i.e., the X-axis direction, along which the beam condenser 123 and the holding table 110 are moved relatively to each other to form modified layers 16 in the ingot 10 is not limited to a direction parallel to a crystal orientation [100], and may be a direction parallel to a crystal orientation <100>.

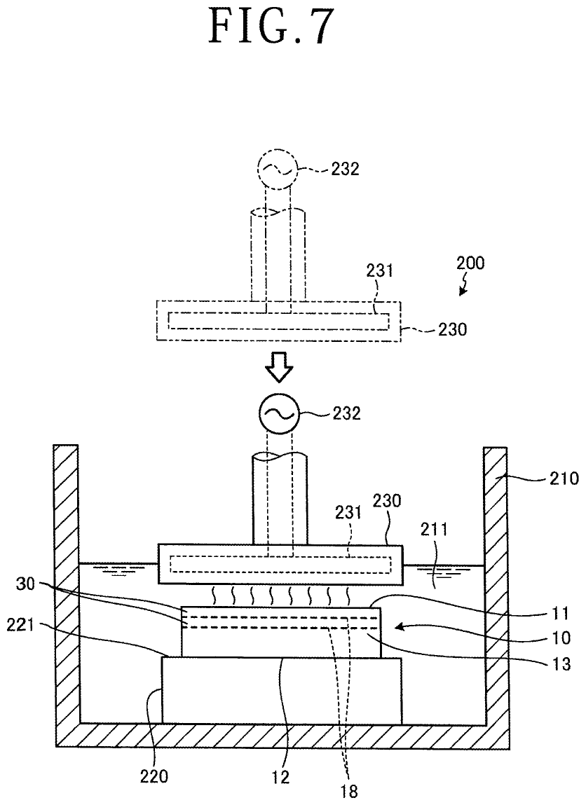

FIG. 7 illustrates in perspective, partly in cross section, an example of the separating step 4 illustrated in FIG. 3. The separating step 4 is carried out after the entire plane processing step 1 has been carried out. The separating step 4 is a step of separating wafers 3 from the ingot 10 along the separation initiating points 18.

The separating step 4 illustrated in FIG. 7 is carried out using an ultrasonic wave applying apparatus 200. As illustrated in FIG. 7, the ultrasonic wave applying apparatus 200 includes a liquid container 210, a holding table 220, an ultrasonic wave applying unit 230, and a moving unit, not illustrated, for lifting and lowering the ultrasonic wave applying unit 230. The liquid container 210 contains a liquid 211 such as pure water, for example.

The holding table 220 is housed in the liquid container 210. The holding table 220 holds the ingot 10 with the separation initiating points 18 formed therein on a holding surface 221 thereof. The ingot 10 held on the holding table 220 is immersed in the liquid 211. The holding surface 221 is made of porous ceramic or the like in the shape of a circular plate. The holding surface 221 represents a flat surface lying parallel to the horizontal plane. The holding surface 221 is connected to a vacuum suction source through a vacuum suction channel, for example. The holding table 220 holds under suction the second surface 12 of the ingot 10 placed on the holding surface 221.

The ultrasonic wave applying unit 230 has an ultrasonic vibrator 231 and a high-frequency power supply 232. The ultrasonic vibrator 231 alternately expands and contracts to generate ultrasonic vibrations in response to an alternating-current (AC) voltage applied thereto. The ultrasonic vibrator 231 is made of piezoelectric ceramic, for example. The high-frequency power supply 232 applies an AC voltage to the ultrasonic vibrator 231. The ultrasonic wave applying unit 230 is movable by the non-illustrated moving unit from a broken-liken position above the liquid container 210 to a solid-line position in the liquid container 210 as illustrated in FIG. 7. The ultrasonic wave applying unit 230 has a surface facing the ingot 10 held on the holding table 220, the surface being larger than the entire upper surface, i.e., the first surface 11, of the ingot 10 in order to fully cover the first surface 11 when the ultrasonic wave applying unit 230 is in the solid-line position.

In the separating step 4, the ingot 10 with the separation initiating points 18 formed therein is placed on the holding table 220 and immersed in the liquid 211 in the liquid container 210. Then, the ultrasonic wave applying unit 230 is moved from the broken-line position to the solid-line position where the ultrasonic wave applying unit 230 is immersed in the liquid 211. The ultrasonic wave applying unit 230 now faces the first surface 11 of the ingot 10 on the holding table 220 with a layer of the liquid 211 interposed therebetween.

Then, the high-frequency power supply 232 applies an AC voltage to the ultrasonic vibrator 231, causing the ultrasonic vibrator 231 to vibrate ultrasonically. The ultrasonic vibrator 231 generates ultrasonic vibrations at a frequency depending on the vibrations thereof. The ultrasonic vibrations generated by the ultrasonic vibrator 231 are propagated through the liquid 211 and applied to the ingot 10 on the holding table 220.

In the separating step 4 illustrated in FIG. 7, when the ultrasonic vibrations are applied through the liquid 211 in the liquid container 210 to the ingot 10, a flat section of the ingot 10 that is positioned closer to the first surface 11 than the uppermost layer of the separation initiating points 18 is separated as a wafer from the remainder of the ingot 10 by the applied ultrasonic vibrations. Another flat section of the ingot that is positioned between the uppermost separation initiating points 18 and the separation initiating points 18 spaced downwardly therefrom thicknesswise of the ingot by a distance corresponding to the thickness 31 is also separated as another wafer 30 from the remainder of the ingot 10 by the applied ultrasonic vibrations. After the separating step 4 illustrated in FIG. 7 has been carried out, both surfaces of each of the wafers 30 manufactured from the ingot 10 are ground, for example, removing surface irregularities off the surfaces of the wafers 30 that have been peeled off from the ingot 10.

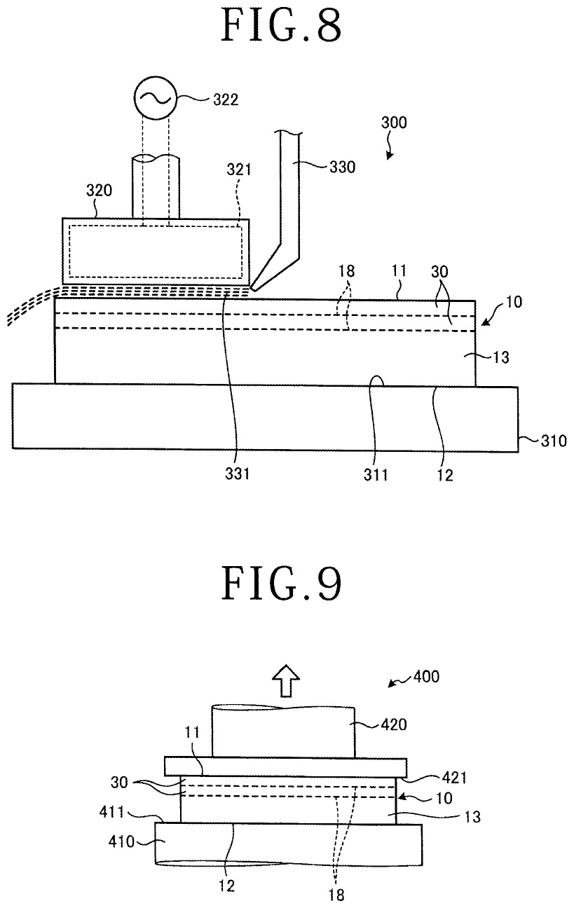

In the example of the separating step 4 illustrated in FIG. 7, a plurality of wafers 30 are simultaneously peeled off from the ingot 10 along the separation initiating points 18 lying in different planes in the ingot 10. Alternatively, wafers 30 may be peeled one at a time from the ingot 10 successively along the layers or planes of the separation initiating points 18. FIG. 8 illustrates in side elevation a first separating step in another example of the separating step 4 illustrated in FIG. 3. FIG. 9 illustrates in side elevation a second separating step in the other example of the separating step 4 illustrated in FIG. 3.

The first separating step is a step of applying ultrasonic waves to the ingot 10 to develop the cracks 17. The first separating step is carried out using an ultrasonic wave applying apparatus 300 illustrated in FIG. 8. As illustrated in FIG. 8, the ultrasonic wave applying apparatus 300 includes a holding table 310, an ultrasonic wave applying unit 320, a liquid supply unit 330, and a moving unit, not illustrated, for moving the ultrasonic wave applying unit 320 and the liquid supply unit 330 relatively to the holding table 310.

The holding table 310 holds the ingot 10 with the separation initiating points 18 formed therein on a holding surface 311 thereof. The holding surface 311 is made of porous ceramic or the like in the shape of a circular plate. The holding surface 311 represents a flat surface lying parallel to the horizontal plane. The holding surface 311 is connected to a vacuum suction source through a vacuum suction channel, for example. The holding table 310 holds under suction the second surface 12 of the ingot 10 placed on the holding surface 311.

The ultrasonic wave applying unit 320 has an ultrasonic vibrator 321 and a high-frequency power supply 322. The ultrasonic vibrator 321 alternately expands and contracts to generate ultrasonic vibrations in response to an AC voltage applied thereto. The ultrasonic vibrator 321 is made of piezoelectric ceramic, for example. The high-frequency power supply 322 applies an AC voltage to the ultrasonic vibrator 321. The ultrasonic wave applying unit 320 is movable with respect to the holding table 310 by the non-illustrated moving unit.

The liquid supply unit 330 supplies a liquid 331 such as pure water, for example, to a space between the upper surface, i.e., the first surface 11, of the ingot 10 held on the holding table 310 and a surface of the ultrasonic wave applying unit 320 that faces the ingot 10 on the holding table 310.

In the first separating step illustrated in FIG. 8, the second surface 12 of the ingot 10 with the separation initiating points 18 formed therein is held under suction on the holding surface 311 of the holding table 310. Then, the ultrasonic wave applying unit 320 is positioned in spaced, facing relation to the first surface 11 of the ingot 10 held on the holding table 310.

Next, the liquid supply unit 330 supplies the liquid 331 to the space between the first surface 11 of the ingot 10 and the ultrasonic wave applying unit 320. While the surface of the ultrasonic wave applying unit 320 that faces the ingot 10 is being immersed in the liquid 331, the high-frequency power supply 322 applies an AC voltage to the ultrasonic vibrator 321 for a predetermined period of time, causing the ultrasonic vibrator 321 to vibrate ultrasonically. The ultrasonic vibrator 321 generates ultrasonic vibrations at a frequency depending on the vibrations thereof. The ultrasonic vibrations generated by the ultrasonic vibrator 321 are propagated through the liquid 331 and applied to the first surface 11 of the ingot 10. The cracks 17 of the separation initiating points 18 of the upper layer in the ingot 10 are now further developed by the ultrasonic vibrations applied from the ultrasonic wave applying unit 320.

The second separating step is a step of peeling off a wafer 30 from the ingot 10 along the separation initiating points 18 of the upper layer where the cracks 17 have further been developed. The second separating step is carried out using a peeling apparatus 400 illustrated in FIG. 9. As illustrated in FIG. 9, the peeling apparatus 40 includes a holding table 410, a peeling unit 420, and a moving unit, not illustrated, for moving the holding table 410 and the peeling unit 420 relatively to each other.

The holding table 410 holds the ingot 10, on which the first separating step has been carried out, on a holding surface 411 thereof. The holding surface 411 is made of porous ceramic or the like in the shape of a circular plate. The holding surface 411 represents a flat surface lying parallel to the horizontal plane. The holding surface 411 is connected to a vacuum suction source through a vacuum suction channel, for example. The holding table 410 holds under suction the second surface 12 of the ingot 10 placed on the holding surface 411.

The peeling unit 420 is able to hold under suction the first surface 11, i.e., the upper surface, of the ingot 10 that is held in abutment against a holding surface 421 thereof. The holding surface 421 is also made of porous ceramic or the like and connected to a vacuum suction source through a vacuum suction channel, for example. The peeling unit 420 is movable by the non-illustrated moving unit toward and away from the holding table 410 that is holding the ingot 10 thereon.

In the second separating step illustrated in FIG. 9, the second surface 12 of the ingot 10 is held under suction on the holding surface 411 of the holding table 410. Then, the peeling unit 420 is moved toward the holding table 410 until it contacts the first surface 11 of the ingot 10, whereupon the holding surface 421 holds the first surface 11 of the ingot 10 under suction.

Then, the peeling unit 420 is moved away from the holding table 410, exerting an upward pull on the ingot whose first and second surfaces 11 and 12 are being held under suction on the holding surfaces 421 and 411. Now, a flat section of the ingot 10 that is positioned closer to the first surface 11 than the separation initiating points 18 of the uppermost layer is separated as a wafer 30 from the remainder of the ingot 10 by the applied upward pull.

The first separating step and the second separating step are repeatedly carried out as many times as the number of the layers of the separation initiating points 18 that have been formed thicknesswise in the ingot 10. Specifically, after the wafer 30 has been peeled off from the ingot 10 along the uppermost layer of the separation initiating points 18 in the second separating step, as described above, the cracks 17 of the separation initiating points 18 of the next layer are further developed in the first separating step, after which a next wafer 30 is peeled off from the ingot 10 in the second separating step. Then, the first and second separating steps are repeated to peel off any more available wafers 30 from the ingot 10.

After the second separating step illustrated in FIG. 9 has been carried out, a grinding step may be carried out to grind a peeled surface of the wafer peeled off from the ingot 10, to remove surface irregularities from the peeled surface. The grinding step may also be carried out to grind a peeled surface of the ingot 10 from which all the wafers 30 have been peeled off along all the layers of the separation initiating points 18, to remove surface irregularities from the peeled surface.

### MODIFICATION

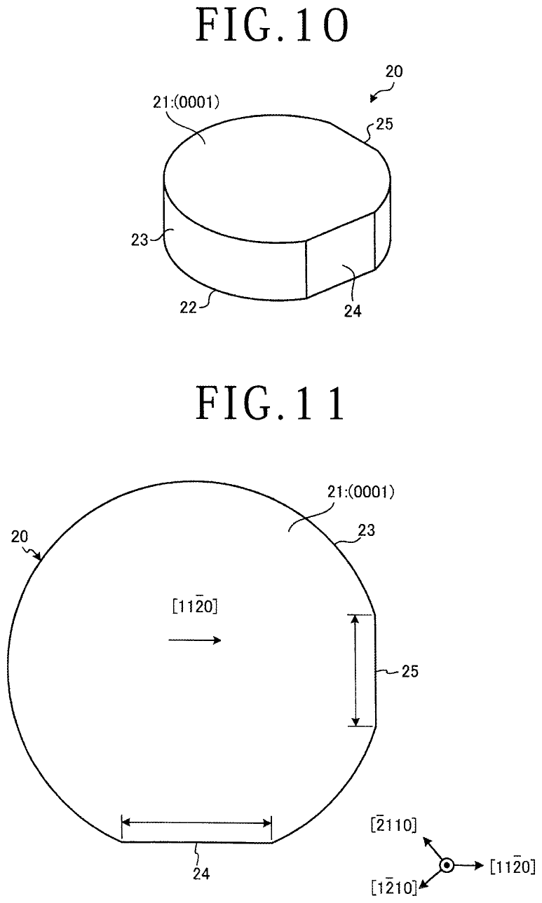

A method of manufacturing a wafer 30 according to a modification of the present invention will be described below with reference to the drawings. In the method of manufacturing a wafer 30 according to the modification, the wafer 30 is manufactured from an ingot 20 illustrated in FIGS. 10 and 11.

### (Monocrystalline GaN Ingot)

FIG. 10 illustrates in perspective the ingot 20 to be processed by the method of manufacturing a wafer 30 according to the modification. FIG. 11 illustrates in plan the ingot 20 illustrated in FIG. 10. The ingot 20 to be processed by the method of manufacturing a wafer 30 according to the modification is made of monocrystalline gallium nitride (GaN) and is of a cylindrical shape in its entirety. According to the modification, the ingot 20 is a hexagonal monocrystalline GaN ingot. The ingot 20 has a first surface 21, a second surface 22, a peripheral surface 23, a first orientation flat 24, and a second orientation flat 25.

The first surface 21 is a circular flat end face of the ingot 20 that is cylindrical in shape. The first surface 21 represents a top face of the ingot 20 that faces upwardly. The second surface 22 is also a circular flat end face of the ingot 20 that is opposite the first surface 21. The second surface 22 represents a bottom face of the ingot 20 that faces downwardly. The peripheral surface 23 is joined to an outer edge of the first surface 21 and an outer edge of the second surface 22.

The first orientation flat 24 is a flat surface formed on a portion of the peripheral surface 23 and is indicative of a crystal orientation of the ingot 20. The second orientation flat 25 is a flat surface formed on a portion of the peripheral surface 23 and is indicative of a crystal orientation of the ingot 20. The second orientation flat 25 lies perpendicularly to the first orientation flat 24. The first orientation flat 24 is longer than the second orientation flat 25 along the first and second surfaces 21 and 22.

The first surface 21 represents a crystal plane (0001). The first orientation flat 24 represents a crystal plane (−1100). The second orientation flat 25 represents a crystal plane (11-20).

The method of manufacturing a wafer 30 according to the modification is of basically the same sequence as the method of manufacturing a wafer 30 according to the embodiment, except that, in the separation initiating point forming step 2 of the method of manufacturing a wafer 30 according to the modification, the processing feed direction, i.e., the X-axis direction, is set to a direction parallel to a crystal orientation <11-20> of the ingot 20.

As described above, with the methods of manufacturing a wafer 30 according to the embodiment and the modification, the focused spots 127 of the laser beams 121 into which the laser beam 121 from the laser oscillator 122 is branched are positioned at respective different depths in the ingots 10 and 20 to form modified layers 16 at the different depths in the ingots 10 and 20. Since the focused spots 127 thus positioned are capable of simultaneously forming separation initiating points 18 as peel-off layers parallel to the flat faces of the ingots 10 and 20 at the different depths in the ingots 10 and 20, the methods have an increased throughput while lowering the loss of the material wasted from the ingots 10 and 20.

The present invention is not limited to the above embodiment and modification. Various changes and modifications may be made therein without departing from the scope of the invention. For example, in the separation initiating point forming step 2, the laser beam 121 that is branched in the depthwise direction and the processing feed direction, i.e., the X-axis direction, may also be branched in the indexing feed direction, i.e., the Y-axis direction.

The present invention is not limited to using the branching unit 125 that includes a diffractive optical element or a spatial light modulator for branching the laser beam 121 from the laser oscillator 122. Rather than the branching unit 125, a beam splitter may branch the laser beam 121 into a plurality of laser beams, and the respective laser beams may be applied to different beam condensers that form a plurality of focused spots of the laser beams at different positions in the depthwise direction and the processing feed direction.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A method of manufacturing a wafer from an ingot having a first surface and a second surface that is opposite the first surface, comprising:
an entire plane processing step of repeating
a separation initiating point forming step of, while positioning a focused spot of a laser beam whose wavelength is transmittable through a material of the ingot within the ingot from the first surface side, moving the focused spot and the ingot relatively to each other along a predetermined processing feed direction, thereby forming in the ingot separation initiating points including modified layers in a plane parallel to the first surface and cracks developed from the modified layers, and
an indexing feed step of indexing-feeding the focused spot of the laser beam relatively to the ingot in a direction perpendicular to the processing feed direction; and
a separating step of separating a wafer from the ingot along the separation initiating points, after the entire plane processing step has been carried out,
wherein the separation initiating point forming step includes forming a plurality of focused spots of the laser beam that are spaced thicknesswise of the ingot from each other in the ingot by a distance corresponding to a thickness of the wafer to be separated from the ingot, thereby simultaneously forming a plurality of layers of separation initiating points at respective different depths in the ingot in the entire plane processing step.

2. The method of manufacturing a wafer according to claim 1, wherein the focused spots formed in the ingot and spaced thicknesswise of the ingot from each other are arranged in respective different positions along the processing feed direction such that the ingot is processed successively at the focused spots in an order from the deepest focused spot to a shallower focused spot.

3. The method of manufacturing a wafer according to claim 1, wherein the ingot is a monocrystalline silicon ingot having a flat surface representing a crystal plane {100}, and the predetermined processing feed direction in the separation initiating point forming step is a direction parallel to a crystal orientation <100>.

4. The method of manufacturing a wafer according to claim 1, wherein the ingot is a monocrystalline gallium nitride ingot having a flat surface representing a crystal plane {0001}, and the predetermined processing feed direction in the separation initiating point forming step is a direction parallel to a crystal orientation <11-20>.

5. The method of manufacturing a wafer according to claim 2, wherein the ingot is a monocrystalline silicon ingot having a flat surface representing a crystal plane {100}, and the predetermined processing feed direction in the separation initiating point forming step is a direction parallel to a crystal orientation <100>.

6. The method of manufacturing a wafer according to claim 2, wherein the ingot is a monocrystalline gallium nitride ingot having a flat surface representing a crystal plane {0001}, and the predetermined processing feed direction in the separation initiating point forming step is a direction parallel to a crystal orientation <11-20>.
